(19) United States
(12) Patent Application Publication
(10) Pub. No.: US 2021/0323517 A1
(43) Pub. Date: Oct. 21, 2021

(54) HYDRAULIC BRAKE SYSTEM

(71) Applicant: TOYOTA JIDOSHA KABUSHIKI KAISHA, Toyota-shi (JP)

(72) Inventor: Yusuke YAMADA, Toyota-shi (JP)

(73) Assignee: TOYOTA JIDOSHA KABUSHIKI KAISHA, Toyota-shi (JP)

(21) Appl. No.: 17/225,310

(22) Filed: Apr. 8, 2021

(30) Foreign Application Priority Data
Apr. 17, 2020 (JP) 2020-073890

(51) Int. Cl. B60T 8/176; B60T 7/04; B60T 17/22; B60T 13/68

(52) U.S. Cl. CPC B60T 8/176; B60T 7/04; B60T 2270/10; B60T 13/686; B60T 2270/88; B60T 17/221

(57) ABSTRACT

A vehicle hydraulic brake system, including: a brake operating member; a master cylinder including (i) an output piston for generating a hydraulic pressure in a pressurizing chamber, (ii) an input piston, and (iii) a rear chamber provided rearward of the output piston; a hydraulic brake provided for a wheel and actuated by the hydraulic pressure to reduce rotation of the wheel; a rear-hydraulic-pressure control mechanism connected to the rear chamber; and a controller including a master cylinder pressure estimator that estimates the hydraulic pressure in the pressurizing chamber and that includes a contact-state estimator that estimates whether the input piston and the output piston are in a contact state; and a contact-state master cylinder pressure estimator that estimates the hydraulic pressure in the pressurizing chamber based on a movement amount of the input piston when the input piston and the output piston are estimated to be in the contact state.

### CROSS REFERENCE TO RELATED APPLICATION

The present application claims priority to Japanese Patent Application No. 2020-073890, which was filed on Apr. 17, 2020, the disclosure of which is herein incorporated by reference in its entirety.

### BACKGROUND

### Technical Field

The following disclosure relates to a hydraulic brake system operated by a hydraulic pressure.

### Description of Related Art

Patent Document 1 (Japanese Patent No. 5976193) discloses a hydraulic brake system for a vehicle including: (i) a brake operating member operable by a driver; (ii) a master cylinder including (a) an output piston configured to generate a hydraulic pressure in a pressurizing chamber, (b) an input piston located rearward of the output piston and connected to the brake operating member, and (c) a rear chamber provided at a rear of the output piston; (iii) a hydraulic brake provided for a wheel of the vehicle and configured to be actuated by the hydraulic pressure in the pressurizing chamber of the master cylinder to reduce rotation of the wheel; (iv) a rear-hydraulic-pressure controller connected to a rear chamber of the master cylinder; and (v) a contact-state determining portion for determining whether the input piston and the output piston are in a contact state in which the input piston and the output piston are in contact with each other. The disclosed hydraulic brake system is configured such that a target hydraulic pressure of the rear chamber is determined to be a larger value when the contact-state determining portion determines that the input piston and the output piston are in the contact state than when the contact-state determining portion determines that the input piston and the output piston are not in the contact state.

### SUMMARY

An aspect of the present disclosure is directed to an improvement in estimation accuracy of the hydraulic pressure in the pressurizing chamber when the input piston and the output piston are in the contact state.

In a hydraulic brake system according to the present disclosure, when it is estimated that the input piston and the output piston are in the contact state, the hydraulic pressure in the pressurizing chamber is estimated based on an amount of a movement of the output piston.

When the brake operating member is operated, it is common that the input piston is moved forward while the output piston is moved forward by a servo pressure Ps supplied to the rear chamber. Accordingly, the input piston and the output piston are in a spaced state in which the input piston and the output piston are spaced apart from each other. The hydraulic pressure level in the pressurizing chamber at this time is determined based on the hydraulic pressure in the rear chamber.

However, when the brake operating member is operated at a high operation speed, for instance, the input piston and the output piston may come into contact with each other, so that the input piston and the output piston may be moved forward together. In this instance, the hydraulic pressure in the rear chamber is lower than the hydraulic pressure in the pressurizing chamber. It is thus difficult to accurately estimate the hydraulic pressure in the pressurizing chamber based on the hydraulic pressure in the rear chamber.

In the present hydraulic brake system, in contrast, when it is estimated that the input piston and the output piston are in the contact state, the hydraulic pressure in the pressurizing chamber is estimated based on the amount of the movement of the output piston, thus improving estimation accuracy of the hydraulic pressure in the pressurizing chamber.

When the input piston and the output piston are in the contact state, the amount of the movement of the output piston, an amount of a movement of the input piston, and an operation amount of the brake operating member correspond to one another. Thus, estimation of the hydraulic pressure in the pressurizing chamber based on the amount of the movement of the output piston, estimation of the hydraulic pressure in the pressurizing chamber based on the amount of the movement of the input piston, and estimation of the hydraulic pressure in the pressurizing chamber based on the operation amount of the brake operating member are equivalent to one another.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a circuit diagram of a hydraulic brake system according to one embodiment of the present disclosure;

FIG. 2 is a view illustrating a brake ECU of the hydraulic brake system and devices connected to the brake ECU;

FIG. 3 is a flowchart indicating a master cylinder pressure estimating program stored in a memory of the brake ECU;

FIG. 4 is a flowchart indicating a hydraulic pressure control program stored in the memory of the brake ECU;

FIG. 5 is a flowchart indicating a slip reduction control program stored in the memory of the brake ECU;

FIG. 6 is a view illustrating a region in which a contact state of an input piston and an output piston is obtained in a master cylinder of the hydraulic brake system;

FIG. 7 is a map representing a relationship between a pressure in a pressurizing chamber of the master cylinder and an amount of a movement of the input piston;

FIG. 8A is a view illustrating an operation of the master cylinder before the input piston and the output piston come into contact with each other; and

FIG. 8B is a view illustrating an operation of the master cylinder in a state in which the input piston and the output piston are in contact with each other.

### DETAILED DESCRIPTION OF THE EMBODIMENT

Referring to the drawings, there will be explained in detail a hydraulic brake system according to one embodiment of the present disclosure. The present hydraulic brake system is applicable to both manual driving vehicles and automated driving vehicles.

### Structure of Hydraulic Brake System

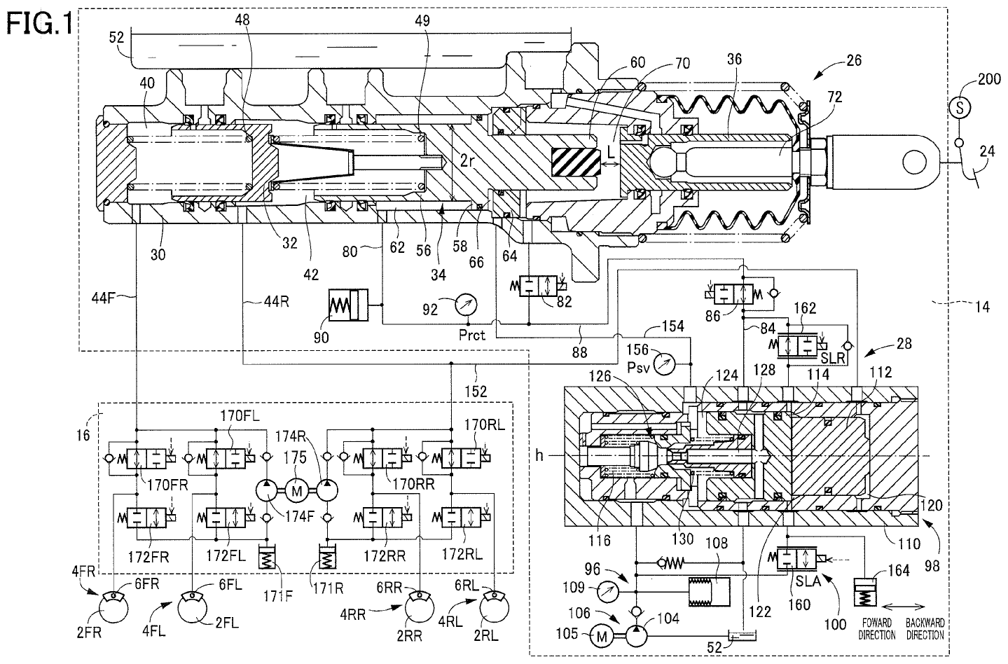

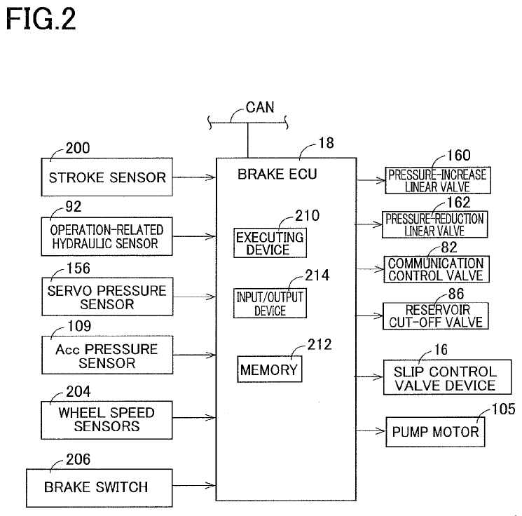

As illustrated in FIG. 1, the hydraulic brake system includes (i) wheel cylinders 6FL, 6FR, 6RL, 6RR of hydraulic brakes 4FL, 4FR, 4RL, 4RR respectively provided for four wheels 2FL, 2FR,2RL, 2RR, i.e., front left and right wheels 2FL, 2FR and rear left and right wheels 2RL, 2RR, (ii) a hydraulic-pressure generating device 14 capable of supplying a hydraulic pressure to the wheel cylinders 6FL, 6FR, 6RL, 6RR, and (iii) a slip control valve device 16, as an electromagnetic valve device, disposed between the wheel cylinders 6FL, 6FR, 6RL, 6RR and the hydraulic-pressure generating device 14. Devices such as the hydraulic-pressure generating device 14 and the slip control valve device 16 are controlled by a brake ECU (Electronic Control Unit) 18 (FIG. 2), as a controller, constituted mainly by a computer.

The hydraulic-pressure generating device 14 includes (i) a master cylinder 26 and (ii) a rear-hydraulic-pressure controller 28 configured to control a hydraulic pressure in a rear chamber of the master cylinder 26.

The master cylinder 26 includes: a housing 30; and output pistons 32, 34 and an input piston 36 fluid-tightly and slidably disposed in the housing 30 so as to be arranged in series with one another.

Pressurizing chambers 40, 42 are defined in front of the respective output pistons 32, 34. The wheel cylinders 6FL, 6FR of the front left and right wheels 2FL, 2FR are connected to the pressurizing chamber 40 via a fluid passage 44F while the wheel cylinders 6RL, 6RR of the rear left and right wheels 2RL, 2RR are connected to the pressurizing chamber 42 via a fluid passage 44R. The hydraulic pressure supplied to the wheel cylinders 6FL, 6FR, 6RL, 6RR cause the corresponding hydraulic brakes 4FL, 4FR, 4RL, 4RR to be actuated, so as to reduce rotation of the corresponding wheels 2FL, 2FR, 2RL, 2RR. The output pistons 32, 34 are urged in a backward direction by respective return springs 48, 49. When the output pistons 32, 34 are located at respective back end positions, the pressurizing chambers 40, 42 are in communication with a reservoir 52.

In the following explanation, each of the devices such as the hydraulic brakes will be referred to without suffixes (FL, FR, RL, RR, F, R) indicative of the corresponding wheel positions where it is not necessary to distinguish the devices by their wheel positions.

The output piston 34 includes (a) a front piston portion 56 located at a front portion of the output piston 34, (b) an intermediate piston portion 58 located at an intermediate portion of the output piston 34 so as to radially protrude, and (c) a rear small-diameter portion 60 located at a rear portion of the output piston 34 and having a diameter smaller than a diameter of the intermediate piston portion 58. The front piston portion 56 and the intermediate piston portion 58 are fluid-tightly and slidably disposed in the housing 30. A space in front of the front piston portion 56 is the pressurizing chamber 42, and a space in front of the intermediate piston portion 58 is an annular chamber 62.

The housing 30 includes an annular inner-circumferential-side protruding portion 64 into which the rear small-diameter portion 60 is fluid-tightly and slidably fitted. In this configuration, a rear chamber 66 is formed at a rear of the intermediate piston portion 58 so as to be located between the intermediate piston portion 58 and the annular inner-circumferential-side protruding portion 64.

The input piston 36 is located rearward of the output piston 34, and a separated chamber 70 is defined between the rear small-diameter portion 60 and the input piston 36. As illustrated in FIG. 1, in an initial state in which the input piston 36 and the output piston 34 are located at respective back end positions thereof, the input piston 36 and the output piston 34 are spaced apart from each other by a distance L. In other words, a distance by which a front end face of the input piston 36 and a rear end face of the output piston 34 are spaced apart from each other in the initial state is a distance L. This distance will be hereinafter referred to as an initial spaced distance L.

A brake pedal 24, as a brake operating member, is linked to a rear portion of the input piston 36 via an operating rod (hereinafter simply referred to as “rod” where appropriate) 72 and other components.

The annular chamber 62 and the separated chamber 70 are connected to each other by a connecting passage 80. A communication control valve 82 is provided in the connecting passage 80. The communication control valve 82 is a normally-closed electromagnetic open/close valve. A stroke simulator 90 is connected to a portion of the connecting passage 80 located on one of opposite sides of the communication control valve 82 that is closer to the annular chamber 62. The portion of the connecting passage 80 in question is connected to the reservoir 52 via a reservoir passage 88. A reservoir cut-off valve 86 is provided in the reservoir passage 88. The reservoir cut-off valve 86 is a normally-open electromagnetic open/close valve.

A hydraulic pressure sensor 92 is provided in the above-indicated portion of the connecting passage 80 located on one of opposite sides of the communication control valve 82 that is closer to the annular chamber 62. The hydraulic pressure sensor 92 detects a hydraulic pressure in the annular chamber 62 and the separated chamber 70 in a state in which the annular chamber 62 and the separated chamber 70 are in communication with each other and are isolated from the reservoir 52. The hydraulic pressure level in the annular chamber 62 and the separated chamber 70 corresponds to a magnitude of an operation force of the brake pedal 24. In this sense, the hydraulic pressure sensor 92 may be referred to as an operation-related hydraulic sensor.

The rear-hydraulic-pressure controller 28 is connected to the rear chamber 66.

The rear-hydraulic-pressure controller 28 includes (a) a high pressure source 96, (b) a regulator 98 as a rear-hydraulic-pressure control mechanism, and (c) an input hydraulic pressure controller 100.

The high pressure source 96 includes: a pump device 106 including a pump 104 and a pump motor 105; an accumulator 108 that accumulates a working fluid ejected from the pump device 106 in a pressurized state; and an accumulator pressure (Acc pressure) sensor 109 configured to detect an accumulator pressure that is a hydraulic pressure of the working fluid accumulated in the accumulator 108. The pump motor 105 is controlled such that the accumulator pressure detected by the accumulator pressure sensor 109 is kept within a predetermined range.

The regulator 98 includes (d) a housing 110 and (e) a pilot piston 112 and a control piston 114 disposed in the housing 110 so as to be arranged in series in a direction parallel to an axis h. A high-pressure chamber 116 is formed in the housing 110 at a position in front of the control piston 114. The high-pressure chamber 116 is connected to the high pressure source 96. A space between the pilot piston 112 and the housing 110 is a pilot pressure chamber 120. A space at a rear of the control piston 114 is a control chamber 122. A space in front of the control piston 114 is a servo chamber 124 as an output chamber. A high-pressure supply valve 126 is provided between the servo chamber 124 and the high-pressure chamber 116. The high-pressure supply valve 126 is a normally closed valve that normally isolates the servo chamber 124 and the high-pressure chamber 116 from each other.

A low-pressure passage 128 is formed in the control piston 114 so as to always communicate with the reservoir 52. The low-pressure passage 128 is open in a front end portion of the control piston 114 and opposed to the high-pressure supply valve 126. Thus, when the control piston 114 is located at its back end position, the servo chamber 124 is isolated from the high-pressure chamber 116 and communicates with the reservoir 52 via the low-pressure passage 128. When the control piston 114 is moved forward, the servo chamber 124 is isolated from the reservoir 52 and the high-pressure supply valve 126 is opened, so that the servo chamber 124 is brought into communication with the high-pressure chamber 116. In FIG. 1, a reference sign 130 denotes a spring that urges the control piston 114 in the backward direction.

The pilot pressure chamber 120 is connected to the fluid passage 44R via a pilot passage 152. Thus, the hydraulic pressure in the pressurizing chamber 42 of the master cylinder 26 acts on the pilot piston 112.

The rear chamber 66 of the master cylinder 26 is connected to the servo chamber 124 via a servo passage 154. Since the servo chamber 124 and the rear chamber 66 are directly connected to each other, a servo pressure Ps that is the hydraulic pressure in the servo chamber 124 is principally equal to the hydraulic pressure in the rear chamber 66. It is noted that the servo pressure Ps is detected by a servo pressure sensor 156 provided in the servo passage 154.

The input hydraulic pressure controller 100 includes a pressure-increase linear valve (SLA) 160 and a pressure-reduction linear valve (SLR) 162. The input hydraulic pressure controller 100 is connected to the control chamber 122. The pressure-increase linear valve 160 is provided between the control chamber 122 and the high pressure source 96, and the pressure-reduction linear valve 162 is provided between the control chamber 122 and the reservoir 52. Electric currents supplied to a coil of the pressure-increase linear valve 160 and a coil of the pressure-reduction linear valve 162 (each hereinafter simply referred to as “supply current”) are controlled to control a hydraulic pressure in the control chamber 122. An electric current supplied to a coil of other electromagnetic valve will be similarly referred to as “supply current”. A damper 164 is connected to the control chamber 122, and the working fluid flows between the control chamber 122 and the damper 164.

The slip control valve device 16 includes (i) pressure-hold valves 170FL, 170FR, 170RL, 170RR each of which is provided between a corresponding one of the pressurizing chambers 40, 42 and a corresponding one of the wheel cylinders 6 of the four wheels 2, (ii) pressure-reduction valves 172FL, 172FR, 172RL, 172RR each of which is provided between a corresponding one of the wheel cylinders 6 and a corresponding one of pressure reduction reservoirs 171F, 171R, and (iii) pumps 174F, 174R each of which is configured to pump up the working fluid in a corresponding one of the pressure reduction reservoirs 171F, 171R to eject the working fluid toward an upstream side of the pressure-hold valves 170. The pumps 174F, 174R are driven by a pump motor 175 common thereto. The hydraulic pressures in the wheel cylinders 6 of the respective four wheels 2 are controlled independently of one another by individually controlling the pressure-hold valves 170 and the pressure-reduction valves 172, so that a slipping state of each wheel 2 is suppressed.

As illustrated in FIG. 2, the brake ECU 18 is constituted mainly by a computer and includes an executing device 210, a memory 212, and an input/output device 214. To the input/output device 214, the operation-related hydraulic sensor 92, the accumulator pressure sensor 109, the servo pressure sensor 156, a stroke sensor 200 as an operation amount sensor, wheel speed sensors 204, a brake switch 206 are connected. Further, the pressure-increase linear valve 160, the pressure-reduction linear valve 162, the communication control valve 82, the reservoir cut-off valve 86, the slip control valve device 16, and the pump motor 105 are connected to the input/output device 214 via respective drive circuits (not illustrated).

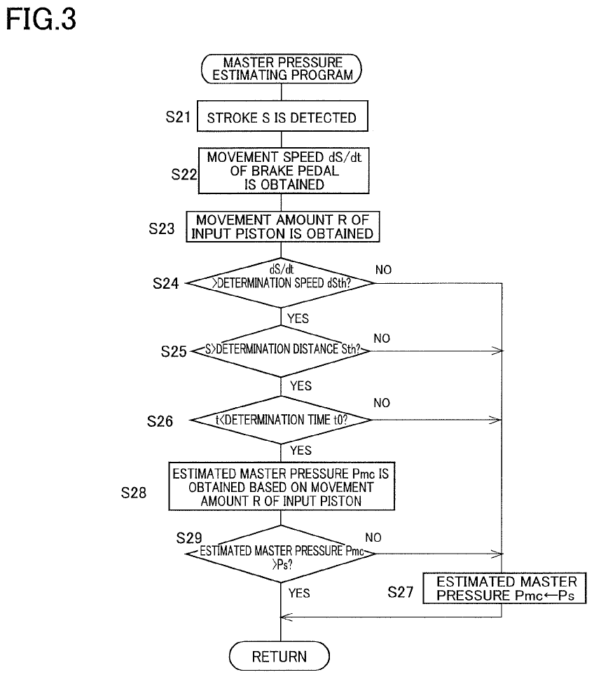

The stroke sensor 200 is configured to detect a stroke of the brake pedal 24. The stroke of the brake pedal 24 is equivalent to an amount of a movement of the brake pedal 24. The wheel speed sensors 204 are provided for the respective four wheels 2 for detecting rotation speeds of the respective wheels 2. The brake switch 206 is switched from OFF to ON when the brake pedal 24 is depressed. The memory 212 stores a plurality of programs such as a master pressure estimating program indicated by a flowchart of FIG. 3.

The hydraulic brake system of the present embodiment is not equipped with a sensor for detecting a master pressure Pmc that is the hydraulic pressure in the pressurizing chambers 40, 42 of the master cylinder 26. Accordingly, the master pressure Pmc is estimated as later explained.

In the thus configured hydraulic brake system, the communication control valve 82 is normally in its open state while the reservoir cut-off valve 86 is normally in its closed state. When the brake pedal 24 is operated, the input piston 36 is moved forward, so that the hydraulic pressure is generated in the separated chamber 70. The amount of the movement the brake pedal 24 is detected by the stroke sensor 200, and the hydraulic pressure in the separated chamber 70 is detected by the operation-related hydraulic sensor 92. Based on the amount of the movement of the brake pedal 24 and the hydraulic pressure in the separated chamber 70, i.e., an operation-related hydraulic pressure, a target servo pressure as a target value of the servo pressure Ps is obtained.

In the rear-hydraulic-pressure controller 28, the hydraulic pressure in the control chamber 122 is controlled by controlling the pressure-increase linear valve 160 and the pressure-reduction linear valve 162, the control piston 114 is moved forward, and the high-pressure supply valve 126 is switched from its closed state to its open state. The servo chamber 124 is isolated from the reservoir 52 and is brought into communication with the high-pressure chamber 116. The servo pressure Ps is increased to a level close to the target servo pressure and is supplied to the rear chamber 66.

In the master cylinder 26, the output pistons 34, 32 are moved forward by the hydraulic pressure in the rear chamber 66, so that the hydraulic pressure is generated in the pressurizing chambers 40, 42. The master pressure Pmc has a level based on the hydraulic pressure in the rear chamber 66, namely, based on the servo pressure Ps.

In a case where the brake pedal 24 is operated at a normal depression speed, the output piston 34 is moved forward in accordance with the forward movement of the input piston 36. Thus, the input piston 36 and the output piston 34 are in a spaced state in which the input piston and the output piston are spaced apart from each other.

A relationship determined based on the configuration of the regulator 98, for instance, is established between the hydraulic pressure in the control chamber 122 and the servo pressure Ps while a relationship determined based on the configuration of the master cylinder 26, for instance, is established between the hydraulic pressure in the rear chamber 66 and the hydraulic pressure in the pressurizing chambers 40, 42. In the present embodiment, an area of a pressure-receiving surface of the output piston 34 with respect to the separated chamber 70 is equal to an area of a pressure-receiving surface of the output piston 34 with respect to the annular chamber 62. Accordingly, the hydraulic pressure in the pressurizing chambers 40, 42 is equal to the hydraulic pressure in the rear chamber 66. It is thus possible to estimate that the master pressure Pmc is equal to a detection value of the servo pressure sensor 156 when the input piston 36 and the output piston 34 are in the spaced state.

On the other hand, in a case where the brake pedal 24 is operated at a high depression speed, for instance, and the input piston 36 is moved forward by a distance not smaller than the initial spaced distance L before the servo pressure Ps is supplied from the rear-hydraulic-pressure controller 28 to the rear chamber 66, the input piston 36 comes into contact with the output piston 34, so that the two pistons 34, 36 are moved forward together. The forward movement of the output piston 34 causes the master pressure Pmc to be increased.

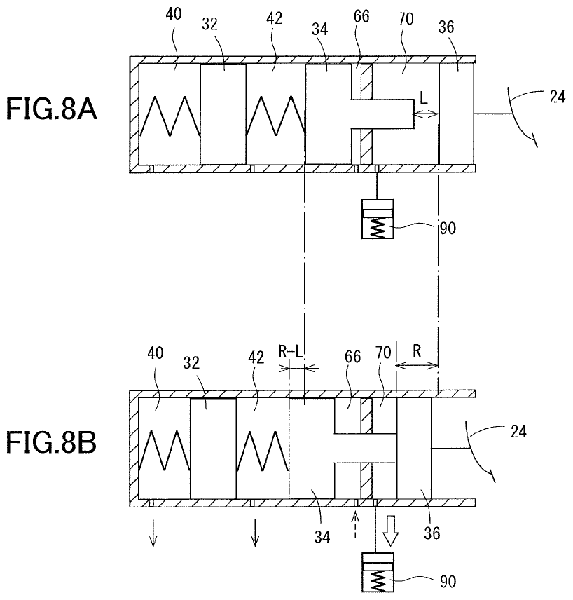

In this case, the working fluid flows out of the separated chamber 70 to the stroke simulator 90 as illustrated in FIGS. 8A and 8B. In the regulator 98, the control piston 114 is not moved forward, the high-pressure supply valve 126 is in its closed state, and the servo chamber 124 is in communication with the reservoir 52. Accordingly, the working fluid is supplied from the reservoir 52 to the rear chamber 66 in accordance with the forward movement of the output piston 34.

In this state, the servo pressure Ps detected by the servo pressure sensor 156 (the hydraulic pressure in the rear chamber 66) is lower than the master pressure Pmc. This makes it difficult to accurately detect the master pressure Pmc based on the servo pressure Ps.

In the present embodiment, a slip reduction or suppression control is executed based on the master pressure that is estimated, i.e., an estimated master pressure Pmc. Specifically, a target brake pressure as a target value of the hydraulic pressure in the wheel cylinder 6 of each wheel 2 is obtained based on a slipping state of each wheel 2. Based on a difference between the target brake pressure of each wheel 2 and the estimated master pressure Pmc, the slip control valve device 16 is controlled. In this instance, if the estimation accuracy of the master pressure Pmc is low, it is difficult to appropriately execute the slip reduction control, making it difficult to appropriately suppress slipping of each wheel 2.

In the present embodiment, therefore, it is estimated whether the input piston 36 and the output piston 34 are in a contact state in which the input piston 36 and the output piston 34 are in contact with each other or in the spaced state. When it is estimated that the input piston 36 and the output piston 34 are in the spaced state, the master pressure Pmc is estimated to be equal to the servo pressure Ps (Pmc=Ps) that is the detection value of the servo pressure sensor 156. When it is estimated that the input piston 36 and the output piston 34 are in the contact state, the master pressure Pmc is obtained based on the amount of the movement of the output piston 34 (hereinafter referred to as the movement amount of the output piston 34). The master pressure Pmc is higher when the movement amount of the output piston 34 is large than when the movement amount of the output piston 34 is small.

In this respect, it is difficult to directly detect the movement amount of the output piston 34. The movement amount d of the output piston 34 is obtained based on an amount R of the movement (movement amount R) of the input piston 36, etc., and the movement amount R of the input piston 36 is obtained based on an amount S of the movement (movement amount S) of the brake pedal 24 detected by the stroke sensor 200.

The movement amount R of the input piston 36 is obtained as a value that is obtained by dividing the movement amount S of the brake pedal 24 (that is the detection value of the stroke sensor 200) by a pedal ratio γ (the movement amount of the brake pedal 24/the movement amount of the input piston 36).

R=S/γ

The movement amount d of the output piston 34 when the input piston 36 and the output piston 34 are in the contact state is equal to a value obtained by subtracting the initial spaced distance L from the movement amount R of the input piston 36.

d=R−L=S/γ−L

Thus, the movement amount d of the output piston 34 can be obtained based on the detection value S of the stroke sensor 200.

In the present embodiment, a relationship between: an amount Q of the working fluid that flows out of the pressurizing chambers 40, 42 of the master cylinder 26, i.e., an outflow amount Q; and the master pressure Pmc is obtained in advance.

The outflow amount Q of the working fluid that flows out of the pressurizing chambers 40, 42 is obtained by multiplying the movement amount d of the output piston 34 by a cross-sectional area A of the output piston 34. The cross-sectional area A is represented as πr² when a radius of the output piston 34 is represented as r.

Q=A*d=πr²*(R−L)

The above expression is transformed, and the following expression is obtained:

R=Q/πr²+L

Based on i) a relationship between the outflow amount Q of the working fluid and the master pressure Pmc and ii) the above expression (R=Q/πr²+L), a relationship between the movement amount R of the input piston 36 and the master pressure Pmc can be obtained as illustrated in FIG. 7, for example. As illustrated in FIG. 7, when the movement amount R of the input piston 36 is smaller than L, the movement amount d of the output piston 34 is 0 and the master pressure Pmc is 0. When the movement amount R of the input piston 36 becomes larger than L, the estimated master pressure Pmc increases with an increase in the movement amount R, and a gradient of increase in the master pressure Pmc is larger in a region in which the movement amount R of the input piston 36 is large than in a region in which the movement amount R of the input piston 36 is small.

In the present embodiment, a map (FIG. 7) representing the relationship between the movement amount R of the input piston 36 and the master pressure Pmc is stored in the memory 212 in advance. Based on the movement amount R of the input piston 36 and the map of FIG. 7, the master pressure Pmc when the input piston 36 and the output piston 34 are in the contact state is estimated.

Whether or not the input piston 36 and the output piston 34 are in the contact state is estimated based on a speed of the movement (hereinafter referred to as “movement speed”) of the brake pedal 24 and the initial spaced distance L, for instance. The output piston 34 is not moved forward or the movement amount of the output piston 34 is considerably small during a time t0 from a time point when the brake pedal 24 starts to be operated to a time point when the servo pressure Ps starts to be supplied to the rear chamber 66, in other words, during a length of time from a time point when the hydraulic pressure in the control chamber 122 starts to be controlled to move the control piston 114 to a time point when the high-pressure supply valve 126 is switched to its open state. It is accordingly estimated that the input piston 36 has come into contact with the output piston 34 in a case where the movement amount R of the input piston 36 is larger than the initial spaced distance L within the time t0, as illustrated in FIGS. 8A and 8B.

Specifically, it is estimated that the input piston 36 and the output piston 34 are in the contact state when the movement speed dR/dt of the input piston 36 is higher than a set speed dRth and the movement amount R of the input piston 36 is larger than the initial spaced distance L. The set speed dRth is obtained by dividing the initial spaced distance L by the time t0, for instance.

dRth=L/t0

dR/dt>L/t0

R>L

As described above, the movement amount R of the input piston 36 can be obtained based on the movement amount S of the brake pedal 24 detected by the stroke sensor 200 (R=S/γ). In the present embodiment, it is estimated that the input piston 36 and the output piston 34 has come into contact with each other when the movement speed dS/dt of the brake pedal 24 is higher than a determination speed (L*γ/t0) and the movement amount S is larger than a determination distance (L*γ).

dS/dt>L*γ/t0

S>L*γ

In the present embodiment, the estimation as to whether the input piston 36 and the output piston 34 are in the contact state is performed within the predetermined time t0 for preventing an erroneous estimation that the input piston 36 and the output piston 34 are in the contact state from being made when the servo pressure Ps increases and the two pistons 36, 34 (i.e., the input piston 36 and the output piston 34) accordingly become spaced apart from each other.

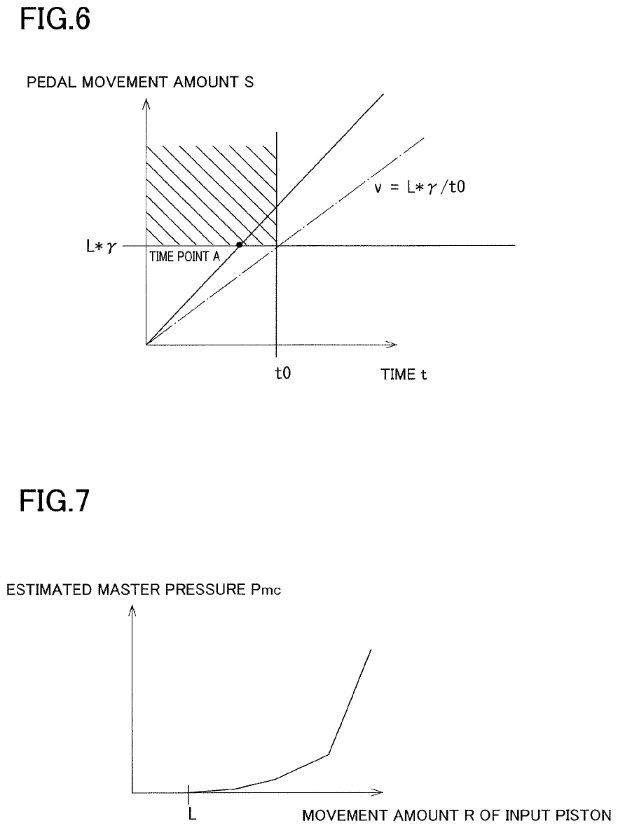

In FIG. 6, the long dashed short dashed line indicates a relationship between a time t and the movement amount S in a case where the brake pedal 24 is operated at the determination speed (L*γ/t0). In a case where the brake pedal 24 is operated at the movement speed dS/dt that is higher than the determination speed, as indicated by the solid line in FIG. 6, it is estimated that the input piston 36 and the output piston 34 are in the contact state at a time point A at which the movement amount S of the brake pedal 24 has reached the determination distance (L*γ).

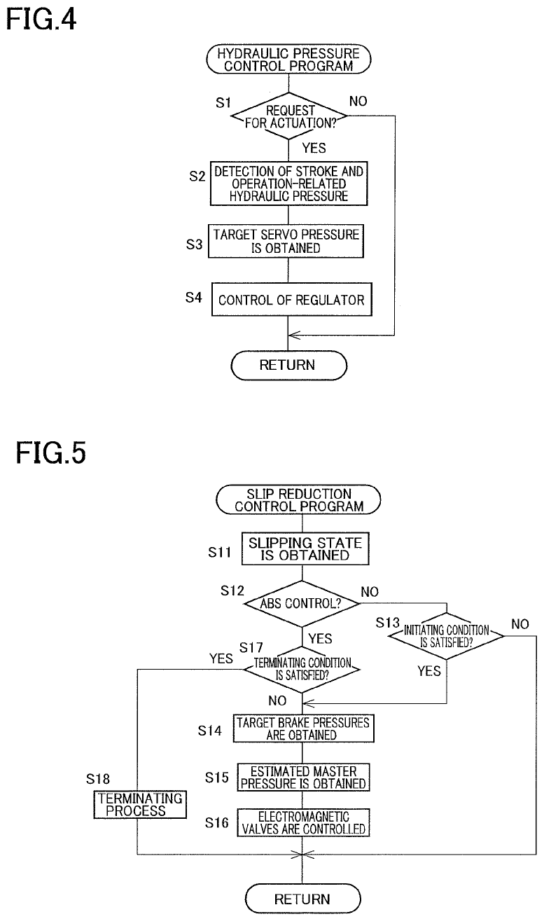

In the present embodiment, a hydraulic pressure control program indicated by a flowchart of FIG. 4 is executed each time when a set length of time elapses.

At Step 1, it is determined whether a request for actuation of the hydraulic brakes 4 is made. (Hereinafter, “Step 1” will be abbreviated as “S1”, and other steps will be similarly abbreviated.) For instance, it is estimated that the request is made when the brake switch 206 is switched from OFF to ON. When a negative determination (NO) is made at S1, S2 and subsequent steps are not executed. When an affirmative determination (YES) is made at S1, on the other hand, the control flow proceeds to S2 at which the movement amount S of the brake pedal 24 is detected by the stroke sensor 200 and the operation-related hydraulic pressure P is detected by the operation-related hydraulic sensor 92. At S3, the target servo pressure is obtained based on the movement amount S and the operation-related hydraulic pressure P. At S4, the hydraulic pressure in the control chamber 122 of the regulator 98 is controlled by controlling the pressure-increase linear valve 160 and the pressure-reduction linear valve 162.

When the input piston 36 and the output piston 34 are in the spaced state, the servo pressure Ps is supplied to the rear chamber 66, so that the output piston 34 is moved forward to generate, in the pressurizing chambers 40, 42, the hydraulic pressure corresponding to the servo pressure Ps.

A slip reduction control program indicated by a flowchart of FIG. 5 is executed each time when a set length of time elapses.

At S11, the slipping state of each wheel 2 is obtained based on the detection value of a corresponding one of the wheel speed sensors 204 that are provided for the respective wheels 2. At S12, it is determined whether an antilock control, as one example of the slip reduction control, is being executed. When a negative determination (NO) is made at S12, it is determined at S13 whether an initiating condition for initiating the antilock control is satisfied. For instance, it is determined that the initiating condition is satisfied when a slip rate indicating the slipping state is not smaller than a set value. When a negative determination (NO) is made at S13, the antilock control is not started. When the initiating condition is satisfied, the antilock control is executed. At S14, the target brake pressure is obtained for each wheel 2 based on the slipping state thereof. At 515, the estimated master pressure Pmc is obtained. At S16, the slip control valve device 16 is controlled based on a difference between the estimated master pressure Pmc and the target brake pressure of each wheel 2. The hydraulic pressures in the wheel cylinders 6 of the respective wheels 2 are controlled independently of each other such that the slipping states of the respective wheels 2 fall within an appropriate range determined by a friction coefficient of a road surface on which the wheels 2 are passing.

When the antilock control is being executed, an affirmative determination (YES) is made at S12, and the control flow proceeds to S17 at which it is determined whether a terminating condition for terminating the antilock control is satisfied. For instance, it is determined that the terminating condition is satisfied when the vehicle stops. When a negative determination (NO) is made at S17, S14-16 are repeatedly executed. When the terminating condition is satisfied, the control flow proceeds to S18 at which a terminating process such as stopping of the pump motor 175 is executed.

A master pressure estimating program indicated by a flowchart of FIG. 3 is executed each time when a set length of time elapses.

At S21, the movement amount S of the brake pedal 24 is obtained by the stroke sensor 200. At S22, the movement speed (dS/dt) of the brake pedal 24 is obtained. At S23, the movement amount R of the input piston 36 is obtained. At S24, it is determined whether the movement speed (dS/dt) of the brake pedal 24 is higher than the determination speed dSth (=L*γ/t0). At S25, it is determined whether the movement amount S is larger than the determination distance Sth (=L*γ). At S26, it is determined whether an elapsed time t, which is a time elapsed after switching of the brake switch 206 from OFF to ON, is shorter than the predetermined time t0 as a determination time.

When at least one of the determinations of S24-26 is negative (NO), it is estimated that the input piston 36 and the output piston 34 are in the spaced state. The control flow then proceeds to S27 at which the estimated master pressure Pmc is obtained as the servo pressure Ps.

When all of the determinations of S24-26 are affirmative (YES), the master pressure Pmc is estimated at S28 based on the movement amount R of the input piston 36 and the map of FIG. 7. At S29, the estimated master pressure Pmc is compared with the servo pressure Ps. When the estimated master pressure Pmc is larger than the servo pressure Ps, the value of the estimated master pressure Pmc is employed. When the estimated master pressure Pmc is smaller than the servo pressure Ps, on the other hand, the estimated master pressure Pmc is obtained as the servo pressure Ps at S27.

In the present embodiment, even when the input piston 36 and the output piston 34 are in the contact state, the master pressure Pmc can be accurately estimated.

This configuration enables, in the slip reduction control, the hydraulic pressures in the wheel cylinders 6 of the respective wheels 2 to be made close to the target brake pressures determined for the respective wheels 2, so that the slip of the wheels 2 can be effectively reduced or suppressed.

In the present embodiment, a rear-hydraulic-pressure control mechanism is constituted by the regulator 98, etc., and a controller is constituted by the brake ECU 18, etc. A portion of the controller that stores the master pressure estimating program indicated by the flowchart of FIG. 3, a portion of the controller that executes the master pressure estimating program, etc., constitute a master cylinder pressure estimator. A portion of the master cylinder pressure estimator that stores S27, a portion of the master cylinder pressure estimator that executes S27, etc., constitute a contact-state master cylinder pressure estimator. Further, a portion of the master cylinder pressure estimator that stores S28 and a portion of the master cylinder pressure estimator that executes S28, etc., constitute a spaced-state master cylinder pressure estimator. Further, a portion of the master cylinder pressure estimator that stores S21-26, a portion of the master cylinder pressure estimator that executes S21-26, etc., constitute a contact-state estimator. Further, a portion of the controller that stores the slip reduction control program indicated by the flowchart of FIG. 5, a portion of the controller that executes the slip reduction control program, etc., constitute a slip reduction controller.

The determination speed is not limited to L*γ/t0 but may be a value determined based on L*γ/t0. For instance, the determination speed may be a value obtained by adding a margin value to L*γ/t0. Likewise, the determination distance is not limited to L*γ but may be a value determined based on L*γ such as a value obtained by adding a margin value to L*γ.

It is to be understood that the present disclosure is not limited to the details of the illustrated embodiment, but may be embodied with various changes and modifications, which may occur to those skilled in the art, without departing from the spirit and the scope of the disclosure. For instance, the brake circuit may have any configuration.

### CLAIMABLE INVENTIONS

(1) A hydraulic brake system for a vehicle, comprising:
a brake operating member operable by a driver;
a master cylinder including (i) an output piston configured to generate a hydraulic pressure in a pressurizing chamber, (ii) an input piston located rearward of the output piston and connected to the brake operating member, and (iii) a rear chamber provided at a rear of the output piston;
a hydraulic brake provided for a wheel of the vehicle and configured to be actuated by the hydraulic pressure in the pressurizing chamber of the master cylinder to reduce rotation of the wheel;
a rear-hydraulic-pressure control mechanism connected to the rear chamber of the master cylinder; and
a controller including a master cylinder pressure estimator that estimates the hydraulic pressure in the pressurizing chamber of the master cylinder,
wherein the master cylinder pressure estimator includes:
   a contact-state estimator that estimates whether the input piston and the output piston are in a contact state in which the input piston and the output piston are in contact with each other; and
   a contact-state master cylinder pressure estimator that estimates the hydraulic pressure in the pressurizing chamber based on an amount of a movement of the input piston when it is estimated by the contact-state estimator that the input piston and the output piston are in the contact state.

The hydraulic pressure in the pressurizing chamber is higher when the amount of the movement of the output piston is large than when the amount of the movement of the output piston is small. It is, however, difficult to directly detect the amount of the movement of the output piston. In the meantime, the amount of the movement of the output piston can be obtained based on the amount of the movement of the input piston when the output piston and the input piston are in the contact state. The amount of the movement of the input piston can be obtained based on the operation amount of the brake operating member (that corresponds to the amount of the movement of the brake operating member). The operation amount of the brake operating member can be detected by the operation amount sensor.

Thus, the hydraulic pressure in the pressurizing chamber can be estimated based on not only the amount of the movement of the input piston but also the amount of the movement of the output piston or the operation amount of the brake operating member.

(2) The hydraulic brake system according to the form (1), wherein the master cylinder pressure estimator includes a spaced-state master cylinder pressure estimator that estimates the hydraulic pressure in the pressurizing chamber based on a hydraulic pressure in the rear chamber when it is estimated by the contact-state estimator that the input piston and the output piston are not in the contact state.

The relationship between the hydraulic pressure in the rear chamber and the hydraulic pressure in the pressurizing chamber is determined based on the configuration of the master cylinder.

(3) The hydraulic brake system according to the form (1) or (2), wherein the contact-state estimator estimates whether the input piston and the output piston are in the contact state based on an amount of a movement of the input piston and a speed of the movement of the input piston.

(4) The hydraulic brake system according to any one of the forms (1) through (3), wherein the contact-state estimator estimates whether the input piston and the output piston are in the contact state before a hydraulic pressure is supplied to the rear chamber by the rear-hydraulic-pressure control mechanism.

(5) The hydraulic brake system according to any one of the forms (1) through (4), further comprising an electromagnetic valve device including at least one electromagnetic valve and disposed between the master cylinder and a wheel cylinder of the hydraulic brake,
wherein the controller includes a slip reduction controller that controls the hydraulic pressure in the wheel cylinder by controlling the electromagnetic valve device based on the hydraulic pressure in the pressurizing chamber estimated by the master cylinder pressure estimator, so as to reduce slipping of the wheel.

What is claimed is:

1. A hydraulic brake system for a vehicle, comprising:
a brake operating member operable by a driver;
a master cylinder including (i) an output piston configured to generate a hydraulic pressure in a pressurizing chamber, (ii) an input piston located rearward of the output piston and connected to the brake operating member, and (iii) a rear chamber provided at a rear of the output piston;
a hydraulic brake provided for a wheel of the vehicle and configured to be actuated by the hydraulic pressure in the pressurizing chamber of the master cylinder to reduce rotation of the wheel;
a rear-hydraulic-pressure control mechanism connected to the rear chamber of the master cylinder; and
a controller including a master cylinder pressure estimator that estimates the hydraulic pressure in the pressurizing chamber of the master cylinder,
wherein the master cylinder pressure estimator includes:
a contact-state estimator that estimates whether the input piston and the output piston are in a contact state in which the input piston and the output piston are in contact with each other; and
a contact-state master cylinder pressure estimator that estimates the hydraulic pressure in the pressurizing chamber based on an amount of a movement of the input piston when it is estimated by the contact-state estimator that the input piston and the output piston are in the contact state.

2. The hydraulic brake system according to claim 1, wherein the contact-state estimator estimates whether the input piston and the output piston are in the contact state based on an amount of a movement of the input piston and a speed of the movement of the input piston.

3. The hydraulic brake system according to claim 1, wherein the contact-state estimator estimates whether the input piston and the output piston are in the contact state before a hydraulic pressure is supplied to the rear chamber by the rear-hydraulic-pressure control mechanism.

4. The hydraulic brake system according to claim 1, further comprising an electromagnetic valve device including at least one electromagnetic valve and disposed between the master cylinder and a wheel cylinder of the hydraulic brake,
wherein the controller includes a slip reduction controller that controls the hydraulic pressure in the wheel cylinder by controlling the electromagnetic valve device based on the hydraulic pressure in the pressurizing chamber estimated by the master cylinder pressure estimator, so as to reduce slipping of the wheel.
